(19) United States
(12) Patent Application Publication
(10) Pub. No.: US 2009/0226651 A1
(43) Pub. Date: Sep. 10, 2009

(54) Method for preparing an oxygen scavenging film and package

(76) Inventors: Dexter A. Chisholm, Unionville, PA (US); Noel M. Hasty, Wilmington, DE (US); Alexander Vincent Tobias, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/074,433

(22) Filed: Mar. 4, 2008

(51) Int. Cl. B32B 27/08; B05D 7/00; B05D 3/02; C09K 3/00

(52) U.S. Cl. 428/35.7; 427/385.5; 427/212; 252/188.28

(57) ABSTRACT

The invention is directed to a method for preparing an oxygen scavenging film and package by inclusion of an oxygen scavenging coating that is activable upon exposure to water vapor during final package assembly. The film includes a composition having a non-aqueous liquid vehicle, a multicopper oxidase enzyme, an oxidizable substrate and an organic binder polymer, wherein the polymer is dissolved or dispersed in the liquid vehicle, wherein the enzyme and the substrate are in particulate form and dispersed in the liquid vehicle; and wherein the liquid vehicle is evaporated.

### FIELD OF INVENTION

The invention relates to a method for preparing an oxygen scavenging film and package by inclusion of an oxygen scavenging coating that is activable upon exposure to water vapor during final package assembly.

### BACKGROUND

Packaging is commonly employed for the transport, storage and display of products en route from the factory to the ultimate user. A critical function of the package is to protect the packaged item from damage or contamination during that journey. In certain applications, such as in food packaging, the package often adds various functionality, such as controlled atmosphere, microwave-heating capability and so on. There is a continuing need in the industry for cost effective methods for preparing packages with an oxygen-scavenging functionality.

Oxidative degradation of packaged goods has long been recognized as a problem affecting both appearance and useful life. Such goods include, for example, food, beverages, cosmetics, personal care products, electronic components/devices and pharmaceuticals,

Enzyme-substrate systems have long been known in the art as effective oxygen scavenging systems. Such systems include a combination of glucose oxidase and glucose; and the use of glucose oxidase, catylase, and glucose impregnated into a sheet used to wrap a packaged good. Other systems include the use of glucose oxidase, catylase, glucose and a water-soluble polymeric binder; and enzyme and substrate incorporated as a thin film between multiple layers. Ascorbate oxidase has been disclosed as an additive to ascorbate-containing foods and juices. Ascorbate oxidase in the form of an immobilized enzyme covalently bound to the inner lining of food packages has been disclosed. Laccase is an oxidase with a wide substrate range and is used as a deoxygenating food additive, where naturally occurring reducing substrates are used by laccase to convert oxygen to water.

U.S. published patent application 2005/0205840 to Farneth et al. discloses a process to remove oxygen from a sealed container wherein an O₂ scavenging system is provided comprising an enzyme and a reducing substrate. The system as described in Farneth is an easily applied water-based formulation. However, the system of Farneth actively scavenges oxygen during storage and while being applied to the container, squandering scavenging capacity and activity.

Yeh et al., J. Polym. Engg. (2007), 27 (4), 245-265, discloses use of compositions of metallic iron and ascorbic acid for scavenging of oxygen.

An oxygen scavenging composition desirably provides rapid reduction of oxygen concentration after package sealing combined with sufficient capacity to maintain reduced oxygen concentration over weeks or months of storage. There is a need for an non-aqueous liquid vehicle based composition that allows the scavenger system to remain inert during formulation, transport, storage, and application in making films, sheets or layers for oxygen scavenging articles.

There is a need for a method for preparing an oxygen reduced package wherein a scavenger composition is utilized which remains inert during formulation, transport, storage, and application. The scavenger composition is used to make films, sheets or layers for oxygen scavenging packaging and becomes active when the composition is exposed to moisture.

### SUMMARY OF THE INVENTION

The present invention is directed to a method for preparing an activable oxygen scavenging film the method comprising contacting an oxygen scavenging coating composition with an inert surface wherein the composition comprises a non-aqueous liquid vehicle, a multicopper oxidase enzyme, an oxidizable substrate, metallic iron, and an organic binder polymer, wherein the polymer is dissolved or dispersed in the liquid vehicle, and wherein the enzyme, substrate, and metallic iron are in particulate form and dispersed in the liquid vehicle; and evaporating the liquid vehicle.

The invention is still further directed to a method for preparing an oxygen reduced package comprising a package having an interior and an exterior, the interior comprising an activable oxygen scavenging coated surface, providing a source of moisture, and sealing the package, wherein said activable oxygen scavenging coated surface comprises a multicopper oxidase enzyme, an oxidizable substrate, metallic iron and an organic binder polymer, wherein the enzyme, the substrate, and the iron are in particulate form and dispersed in the polymer.

### DETAILED DESCRIPTION OF THE INVENTION

The oxygen scavenging composition employed herein—combining multicopper oxidase enzyme, oxidizable substrate, and iron—exhibits a rate of oxygen scavenging that is well in excess of that predicted from the rule of mixtures applied to the combination of enzyme/substrate and iron/substrate compositions that are known in the art. When prepared in the form of a oxygen scavenging coating on a surface interior to a sealed package containing moisture, the oxygen scavenging composition employed herein will provide an unexpectedly rapid decrease in oxygen concentration in the package during the first 100 hours of use.

For the purposes of the present invention, the term “substrate” is employed according to usage in the biochemical art to refer to a redox reactive reagent. An oxidizable substrate is a reagent which will undergo oxidation. The oxidizable substrate will react with oxygen in a reaction which is catalyzed by an enzyme. The term “oxidizable substrate” is synonymous with the term “reductant”. The terms “film,” “sheet,” and “layer” carry their ordinary meanings, sheets being thicker than films. The term “layer” encompasses a discontinuous layer of beads or droplets as well as a continuous layer.

The phrase “diffusive oxygen contact” that there exists a diffusive path which an oxygen molecule may traverse between the surface of the oxidatively degradeable item and the oxygen scavenging coating. The oxygen scavenging coating is considered useful if it reduces the oxygen concentration in the vicinity of an oxidatively degradeable item.

For the purposes of the description herein, the oxygen scavenging coating is disposed on a surface present in the interior of a package. The surface may or may not be associated with an integral part of the package itself. For example, if the package is a box, the oxygen scavenging coating may be disposed on the inner wall of the box. However, the invention is equally operable if the oxygen scavenging coating is disposed on a separate piece of film or cardboard or the like, and inserted into the already formed box.

The present invention may be employed in the fabrication of a package of any design in the art without limitation except that the present invention requires a package sealing step. If the package is not sealed, the oxygen scavenging function imparted by the process will rapidly be overwhelmed by the unabated influx of fresh oxygen from outside the package. For the purpose of the present invention, the term “sealed” shall be understood to mean in practical terms that the rate of oxygen diffusion into the sealed package is lower than that into the unsealed package. Sealing may be effected by taping, gluing, melting, gasketing, crimping, twisting, wrapping, and any other means, such as is known in the art. Accordingly, the present invention encompasses rigid packaging, such as that employing cardboard, metal, wood, glass, and the like. The present invention also encompasses “flexible packaging.”

Flexible packaging is often preferred commercially to rigid packaging because of lower materials cost, reduced transportation cost, lower volume, lower weight, and lower storage cost. Thin-walled molded plastic containers or melt-cast extruded thermoplastic polymer films are typically employed in flexible packaging. Molded containers may be produced by injection molding, blow molding, or thermoforming. Typical extruded films useful in flexible packaging applications are 25-75 micrometers in thickness. In any given application, the selection of the specific polymer and the specific package design will depend upon the specific requirements of the end use.

Common package types made of flexible packaging include, but are not limited to, wraps, bags, and pouches of many shapes and sizes. In one embodiment a package can be formed by wrapping the food or other item with a flexible film coated on the inner side with the oxygen scavenging coating according to the present invention. Wrapping may be performed by hand or by machine.

In another embodiment, the item to be packaged is inserted into a preformed package with a sealable close. The preformed package, having an interior and an exterior, will comprise within the interior thereof a surface coated with the oxygen scavenging coating.

Some packages are formed in a step that occurs well before the product is packaged. Then the product is placed inside the package and the package is secured. In such instances the oxygen scavenging coating may be applied to the surface of a separate package insert—that is to say an article coated with the oxygen scavenging coating held in a dry environment—such as a dessicator or a sealed pouch—prior to insertion in the package. Alternatively, the oxygen scavenging coating can be kept in the inactive state by completing the oxygen scavenging coating process—that is, removing the liquid vehicle—just prior to insertion into the package.

Materials suitable for use as the packaging material in the present invention are selected according to the properties needed for performance requirements. Particularly of interest are so-called barrier properties, such as permeability to oxygen, CO₂, and moisture, as well as to liquids, such as oils, greases, organic solvents, (e.g., gasoline), or liquid water.

Other properties of interest in package design include toughness, strength, ductility, rigidity, cut resistance, puncture resistance and low/high temperature properties. Sealability is an important property. Heat sealability may be characterized by heat seal and hot tack strength, heat seal and hot tack initiation temperatures, seal-through-contamination performance, caulkability, and seal integrity. Hot tack refers to the strength of the seal while still in the molten state. Caulkability refers to the ability of the sealant material to flow, filling in gaps around folds, wrinkles, or product contaminants. While it is of importance that the package be sealed, any sealing material and method of sealing commonly employed in the art is suitable for use.

Polymer materials suitable for use as the packaging material include but are not limited to linear low density polyethylene polypropylene, low density polyethylene, high density polyethylene, polyolefin plastomers, ultralow density polyethylene, metallocene-catalyzed linear low density polyethylene, enhanced polyethylene, ethylene vinyl acetate copolymers, acid copolymers and ionomers, polyamides, such as nylon 6,6, nylon 6, nylon 12 and the like; polyesters, such as, poly(ethylene terephthalate), ethylene vinyl alcohol (EVOH), and poly(vinylidene chloride) (PVDC). These and other polymers may be laminated one to another, or combined with other materials, such as foil or paper.

Suitable polymer films include melt blown film, melt cast film or extrusion coated film on, e.g., paper or aluminum foil. All of these are known in the art. Blown films are made by melting and pumping polymer through an annular die. Cast films are made by melting and pumping polymer through a flat die onto a rotating quench drum. The extrusion oxygen scavenging coating process is similar to the cast film process except that the molten polymer is coated directly onto another material. Films may also be cast from solution. Coextruded films are also suitable. Oriented films are also suitable. Any of the films so produced are suitable to provide the surface upon which the oxygen scavenging coating composition supra is coated.

Lamination is useful for combining packaging films which cannot be combined in coextrusion, such as a lamination of aluminum foil and a polyethylene film. Suitable laminations may include multiple types of polymer film, paper, and foil. Laminations can be categorized into main types: adhesive laminations and melt laminations. In adhesive laminations, the substrates are combined using an adhesive material. In extrusion laminations the substrates are adhered together using a molten polymer, often LDPE, as the adhesive layer. Laminations are highly useful for providing barrier to oxygen and moisture. The barrier functionality may be provided by foil or a high barrier polymer, such as EVOH or PVDC.

Metallization is another means for achieving a high barrier packaging film, providing an excellent barrier to oxygen and water. Metallized films are used commonly for potato chip bags, nuts and salty snacks.

Packages themselves may be formed in situ as part of the packaging process, or formed in a separate process and then employed in a filling and sealing operation. Several industrial scale methods for package fabrication, filling, and sealing are known in the art. These include so called vertical form/fill/seal (VFFS), horizontal form/fill/seal (HFFS), and thermoform/fill/seal. In VFFS operations, often used for fresh produce, tubular shaped continuous film moves in a vertical direction over a filling tube. Horizontal seals are made to define the bottom and top of the bag so formed, respectively before and after filling has taken place. In HFFS operations, the film moves in a horizontal direction during the packaging step rather than vertically. Thermoform/fill/seal packaging is frequently used for bacon and processed meats.

In one embodiment the package comprises fresh red meat. Fresh red meat is typically transported in large pieces from the slaughter house to local butcher shops in large bags that provide a barrier to oxygen. As well as oxygen barrier, package toughness and seal integrity are key requirements for these bags. These bags may contain PVDC or EVOH as a barrier material, along with layer of various PE resins for toughness and sealability. According to the present invention, at least a portion of the interior of the bags will be coated with the oxygen scavenging coating composition formed as described supra; or, alternatively there will be a separate insert comprising the oxygen scavenging coating composition suitable for the practice of the invention.

Similarly, most processed meat, such as luncheon meat, ham, bologna, and salami are packaged in oxygen-barrier films. In addition to low permeability to oxygen, toughness and seal integrity are necessary to maintaining the low oxygen concentration atmosphere inside the package. According to the present invention, the interior of the package will contain the oxygen scavenging coating composition.

Cheese packaging is another application that requires low oxygen concentrations. According to the present invention, cheese is packaged in packages comprising an interior coated surface comprising the composition applied according to the present invention. Other food products as well, including fresh cut produce, require control over oxygen in the package, and are well-suited to the application of the process.

The process of the present invention may be employed to provide oxygen scavenging coatings or layers in multi-layer structures, lids, caps, labels, pads, containers and other packaging materials. In order to keep the oxygen scavenging composition from contact with the packaged food item, it is suitable to employ a multi-layer structure wherein the oxygen scavenging coating is disposed under a polymeric scavenger barrier layer. When rapid removal of oxygen from a package is desired, a polymer having high oxygen permeability is preferred for the scavenger barrier layer. In certain applications, for example when a composition comprising a polymer and oxygen scavenging composition is used as a cap liner in a packaging article, it is desirable that oxygen moves rapidly from the inside of the container, e.g. a bottle, to contact the oxygen scavenging composition. Oxygen may be present in the package as a result of the manufacturing process or in some cases it may diffuse into the package during storage.

In other applications, the polymer present in the oxygen scavenging composition will act as a barrier to permeation of oxygen from outside the packaging material to inside the packaging material. In such applications, it may be desirable to utilize a polymer having low oxygen permeability but high water permeability. An example of such a polymer is a copolymer of ethylene and vinyl alcohol (EVOH).

Other embodiments of the invention are laminates, by which is meant multi-layered structures. Laminates of the invention may comprise two or more layers. An oxygen scavenging composition suitable for the practice of the invention will comprise a first layer. Such compositions may include an additional polymer or polymers to form the material that comprises this first layer. As described above, the oxygen scavenging compositions may further include additional components that do not interfere with the oxygen scavenging reaction. The second layer may be formed of any material, including the same composition as the first layer. The second layer may comprise another polymeric layer, a metal layer or metal foil layer, a ceramic or glass layer, a coextrudable adhesive layer, a hot melt adhesive layer, a solvent based adhesive layer, a fabric or other porous layer, for example Tyvek® industrial packaging.

Examples of useful laminates of these types include flexible film layers of the following constructions: polypropylene/adhesive tie layer/oxygen scavenging composition suitable for the practice of the invention/adhesive tie layer/ionomeric polymer; polyethylene/adhesive tie layer/ethylene vinyl alcohol/adhesive tie layer/oxygen scavenging composition suitable for the practice of the invention/adhesive tie layer/polypropylene; metallized Mylar® polyester film/adhesive tie layer/oxygen scavenging composition suitable for the practice of the invention/adhesive tie layer/sealant layer. The first of these constructions might be useful as a lid material with the polypropylene as the outside layer. The second would be suitable for film wrap. The third would be suitable as a lid material, with the metallized Mylar® polyester film as the outside layer. A laminate structure that would be useful for bottle caps is one having an outside layer of polypropylene and a second layer of an oxygen scavenging composition suitable for the practice of the invention wherein the polymer is ethylene vinyl acetate. A three-layer laminate structure useful for bottle caps is one having aluminum as an outside layer, an oxygen scavenging composition suitable for the practice of the invention wherein the polymer is ethylene vinyl acetate as a second layer, and ethylene vinyl acetate as the inside layer.

A laminate useful as a cup or tray material is one formed of an outside layer of polypropylene, a second layer that is an adhesive tie layer, a third layer that is EVOH, a fourth layer that is an adhesive layer, a fifth that is an oxygen scavenging composition suitable for the practice of the invention wherein the polymer is polyethylene, and an inside layer that is polyethylene. Another laminate useful as a lid material is one formed of an outside layer of MYLAR® polyester film, a second layer that is a co-extrudable adhesive, a third layer that is an oxygen scavenging composition suitable for the practice of the invention wherein the polymer is polyethylene, and an inside layer that is APPEEL® lidding resin.

Typical polymers used in film layers for packaging include polypropylene, low density polyethylene, polylactic acid, polyethylene terephthalate and high density polyethylene. Tie layers formed of coextrudable adhesives, such as BYNEL® are commonly used in such constructions.

The oxygen scavenging coatings and laminates can be fabricated, for example, by melt processing, into shaped articles or films used in packaging applications.

In certain embodiments the compositions will scavenge oxygen in a way that removes oxygen from packaged material. In order to provide a lengthy period of oxygen scavenging activity, the scavenging composition should be separated from air outside the package by a barrier that resists permeation of oxygen. One method is to provide a thick container wall layer, for example a 10 mil thick polypropylene layer.

Alternatively, a thin layer of a polymer that has low permeability to oxygen can provide longer life for the scavenging composition. For example, ethylene vinyl alcohol copolymers (EVOH) of 0.2 mil thickness would provide the same protection as a 20 mil layer of the more permeable polypropylene. Once protected from external oxygen, the location of the oxygen scavenging layer can be varied within the package. For example, a laminate layer comprising the oxygen scavenging composition may be a separate label affixed to the inner wall of the package, a layer in the lid of a cup or tray, a bottle cap liner, or a layer of a laminated container wall. An example of the latter would be a laminate of polypropylene, Bynel® co-extrudable adhesive resin, EVOH, Bynel® co-extrudable adhesive resin, layer comprising the oxygen scavenging composition, Bynel® adhesive resin, polypropylene, with the EVOH layer located between the outside layer and the oxygen scavenging layer.

Packaged oxygen sensitive materials that may be protected using the compositions of the invention include but are not limited to milk, yogurt, cheeses, soups, beverages, such as wine, beer and fruit juices, pre-cooked meals, pharmaceuticals, and powders or materials that are difficult to treat by nitrogen purging, such as flour or noodles. The package hereof protects packaged articles from the secondary effects of oxygen, such as insect damage, fungal growth, mildew and bacterial growth.

In the instant invention, the non-aqueous nature of the liquid vehicle allows the dispersed scavenger particles to remain inert until the final stage of application when the liquid vehicle is driven off and the scavenging is activated by exposure to moisture.

The present invention provides a method comprising:

contacting a surface with a oxygen scavenging coating composition to form a coated surface, the oxygen scavenging coating composition comprising a mixture of a liquid vehicle, an organic polymer, and, a particulate mixture comprising a multicopper oxidase enzyme, an oxidizable substrate, and iron;

evaporating the liquid vehicle thereby forming an activable oxygen scavenging coated surface in the form of a film, sheet, or layer comprising a mixture of the polymer and the particulate mixture;

fabricating a package having an interior and an exterior, wherein the package comprises in the interior the inactive oxygen scavenging coated surface;

contacting the inactive oxygen scavenging coated surface with moisture to form an activated oxygen scavenging coated surface;

incorporating into the interior of the package an oxidatively degradeable article, in diffusive oxygen contact with the oxygen scavenging coated surface, whether or not activated;

sealing the package to reduce oxygen transport from the exterior of the package to the interior of the package.

Optionally, a functional barrier may be employed at a location to effectively sequester contents of a package from the activable oxygen scavenging coated surface. The purpose of the functional barrier is to ensure that the scavenging composition is sequestered in such a manner that it does not directly contact the contents of the sealed container. The functional barrier should be permeable to O₂, such that O₂ within the headspace of the sealed container may diffuse through the functional barrier and thereby react with the O₂ scavenging composition. The package can be designed so that the activated oxygen scavenging coated surface is in diffusive oxygen contact with the food item, but is prevented from actual physical contact by virtue of compartmentalization, or a functional barrier. One such physical barrier may be an oxygen and moisture permeable film laminated to the activated oxygen scavenging film.

Typically, functional barrier materials will include polymeric materials in the form of films or matrices. Suitable polymer materials that could be used, as well as details concerning each polymer's O₂ permeabilities, are found in: 1.) “Permeability Properties of Plastics and Elastomers, 2^{nd} Ed.”, Liesl K. Massey, ed, Plastics Design Library, Norwich: N.Y. (2003); 2.) “Barrier Polymers and Structures”, Koros ed, ACS Symposium Series, American Chemical Society: Washington D.C., pp 111 & 163 (1990); and, 3.) Stanneft, Poly Eng & Sci, 18(15):1129-1134 (1978). Thus, for example, a non-limiting list of polymers suitable in the present invention include: polyacrylonitrile, polymethacrylonitrile, polyvinylidene chloride, polyethylene, terephthalate, Nylon 6®, polyvinyl chloride, polyethylene, cellulose acetate, cellulose acetate butyrate, cellulose diacetate, polycarbonate, polystyrene, Neoprene®, Teflon®, poly 4-methyl pentene-1 and poly dimethyl siloxane. Of course, any polymer that is inert to the O₂ scavenging system and the contents of the sealed container, and that has sufficient permeability to O₂, can be used in the invention herein.

The functional barrier so employed may be included in the laminate structures as described above or it may be a free-standing barrier film or other configuration not itself in direct contact with the oxygen scavenging layer.

Alternatively, air itself may serve as an appropriate functional barrier when there is no possibility of direct contact between the scavenging composition and the contents of the sealed container.

One must consider the specific application in which the O₂ scavenging system is to be used, prior to selection of a specific functional barrier. For example, in some situations, a material that would only allow water vapor to pass through the material would be required to enable activation of the system, since a material that would allow liquid water to pass through the material would not be a suitable functional barrier because the O₂ scavenging composition and the contents of the sealed container could leach through a shared aqueous solution.

In an embodiment, the multicopper oxidase enzyme and the oxidizable substrate are in particulate form wherein they are combined to form a mixture of particles of oxidizable substrate and particles of multicopper oxidase enzyme. In another embodiment, the multicopper oxidase enzyme and the oxidizable substrate are in particulate form wherein they are a mixture of substrate particles having disposed upon the surfaces a multicopper oxidase enzyme. In another embodiment, the multicopper oxidase enzyme and the oxidizable substrate are in particulate form wherein there is an intimate association of substrate and a multicopper oxidase enzyme wherein the enzyme is dispersed throughout the body of the substrate particles.

The average equivalent spherical diameter of the particles of the multicopper oxidase enzyme and the oxidizable substrate as determined by light scattering techniques ranges from 1 to 100 micrometers, and preferably, 1 to 20 micrometers.

Multicopper oxidase enzymes are suitable for use in the present invention. Examples include laccase and ascorbate oxidase.

Laccase (E.C. 1.10.3.2, Systematic Name: Benzenediol:oxygen oxidoreductase) and ascorbate oxidase (E.C. 1.10.3.3 Systematic Name: L-ascorbate:oxygen oxidoreductase) are two classes of multicopper oxido-reductases which perform—in combination with a suitable substrate—a four-electron reduction of molecular O₂ to form H₂O.

Laccases occur in plants, fungi, yeasts and bacteria. Best known laccase producers are fungi. Fungal laccases suitable for the purposes of the present invention herein include (but are not limited to) those isolated from Ascomycetes and Basidiomycetes. More specifically, illustrative sources of fungal laccases include those from: Aspergillus, Neurospora, Podospora, Botrytis, Collybia, Fomes, Lentinus, Pleurotus, Trametes, Rhizoctonia, Coprinus, Psaturella, Myceliophthora, Schytalidium, Polyporus, Phlebia, Coriolus, Hydrophoropsis, Agaricus, Cascellum, Crucibulum, Myrothecium, Stachybotrys, Sporormiella, Trametes versicolor, T. villosa, Myceliophthora thermophilia, Stachybotrys chartarum, Coriolus hirsutus and C. versicolor. Commercially available laccases are available from sources, such as Wacker Chemie (München, Germany; T. versicolor), Novozymes (Franklinton, N.C.; M. thermophilia), Genencor (Palo Alto, Calif.; S. chartarum), Sigma-Aldrich (St. Louis, Mo.; C. versicolor) and SynectiQ (Dover, N.J.; C. hirsutus).

The source of laccase is not limiting to the invention. Thus, although fungal laccases are preferred, laccases can also be obtained from transgenic yeasts (e.g., Pichia, Saccharomyces and Kluyveromyces), transgenic fungi (e.g., Aspergillus, Trichoderma or Chrysosporium) and transgenic plants that serve as production hosts to express laccase genes cloned from other organisms (e.g., of fungal origin). Additionally, laccase may be produced from a variety of bacteria (e.g., Escherichia, Bacillus and Streptomyces).

Additionally non-native laccases may, also, be used in the invention. These modified laccases can be obtained by traditional mutagenesis (e.g., chemical, UV) or directed evolution methods (e.g., in vitro mutagenesis and selection, site-directed mutagenesis, error prone PCR, “gene shuffling”), wherein the techniques are designed to alter the amino acid sequence of the protein with the objective of improving the characteristics of the laccase. Examples of improvements would include altering substrate specificity or increasing the stability of the native enzyme.

For a general review of ascorbate oxidases, see for example: Dawson, C. R., K. G. Strothkamp and K. G. Krul. Ann NY Acad Sci. 258:209-220 (1975).

Ascorbate oxidases are known to originate from plants. Ascorbate oxidases suitable for the purposes of the present invention include (but are not limited to) those isolated from tobacco, soybean, cucumber, squash plants, etc. More preferred, however, are those thermally stable ascorbate oxidases that are isolated from fungi, and in particular, from species of the genus Acremonium (e.g., see U.S. Pat. No. 5,180,672).

Suitable reducing substrates—or, synonymously, oxidizable substrates or reductants—are compounds that are capable of donating electrons to the type 1 copper site of a multicopper oxidase, such as laccase or ascorbate oxidase. Laccase is well known to be able to accept electrons from a wide range of phenolic molecules, such as flavonoids and quinones, as well as some small non-phenolic molecules. Substrates include ascorbic acid and salts thereof, such as calcium ascorbate or sodium ascorbate, isoascorbic acid and salts thereof, and combinations thereof.

In an embodiment, substrate particles having a multicopper oxidase enzyme disposed upon the surfaces thereof are first prepared, and then combined with iron particles to form the composition hereof. In another embodiment, substrate particles having the multicopper oxidase enzyme dispersed throughout the body thereof are first prepared, then combined with iron particles to form the composition hereof.

The average equivalent spherical diameter of the particles of the oxidizable substrate as determined by light scattering techniques ranges from 1 to 100 micrometers, and preferably, 1 to 20 micrometers. The iron suitable for use in the present invention is metallic iron in particulate form, with average particle size in the range of 10 nm to 100 μm, preferably 100 nm to 50 μm. Suitable iron particles are widely available commercially from, among others, BASF, North American Höganäs, Toda Kogyo, and Alfa Aesar.

The relative amounts of the ingredients of the composition in any specific embodiment hereof will be dictated by the particular requisites of the particular use for which it is intended. The relative concentration of the multicopper oxidase enzyme and the oxidizable substrate range from one part by weight of the enzyme combined with 20 to 1000, preferably 50 to 500, parts by weight of the oxidizable substrate.

There is no particular limit on the relative concentrations of iron and the enzyme/substrate in the composition hereof. The weight ratio of iron to enzyme/substrate may range from 5:95 to 95:5. It is found in the practice of the invention that compositions having 15-25% by weight of iron particles exhibit the greatest enhancement in the rate of oxygen removal in a closed package.

Although the particular morphology of the mixture hereof will influence performance details in particular situations, no one particular way of preparing the composition hereof is preferred over another. The critical factor in preparing the compositions hereof is to prepare a morphology that, upon introduction of moisture thereto enables the oxygen scavenging chemistry to proceed. While the invention hereof is in no way limited to any particular chemical mechanism, it is speculated by the inventors hereof that several chemical reactions may be occurring simultaneously. The may include the enzyme catalyzed reaction of the substrate with oxygen in aqueous solution, the aqueous salt activated reaction of iron with oxygen, also in aqueous solution, and the iron activated reaction of the substrate with oxygen, also in aqueous solution.

Any method or combination of methods, for preparing a mixture of the multicopper oxidase enzyme, the oxidizable substrate, and the iron may be employed. In the process for preparing the composition hereof, it is preferred to combine the enzyme and substrate mixture before adding in the iron therewith. However, the process for preparation of the composition hereof is not thereto limited. Combination of enzyme and substrate is accomplished advantageously in aqueous solution, but may also be performed in non-aqueous dispersions thereof, such as in alcohol. However the enzyme/substrate mixture is effected, it is preferred to disperse the resulting composition in particulate form with the iron particulates in a non-aqueous vehicle, such as but not limited to ethanol.

In one embodiment, the enzyme and substrate are combined in aqueous solution, followed by drying and milling to produce fine particles, in the range of 1-100 micrometers in size. Spray drying is one method of producing small homogeneous particles which minimize the amount of grinding needed to achieve a desired particle size. After thus combining the enzyme and substrate, the iron may be combined therewith.

In another embodiment, a mixture is formed by subjecting particles of the substrate to contact with an aqueous solution of the enzyme. Many methods for performing the requisite contacting operation are known including drum oxygen scavenging coating, pan oxygen scavenging coating, fluidized bed drying, fluidized bed mixing, v-cone blending, and injector treatment methods. The substrate particles may be first ground as necessary into the 1-100 micrometer size range, prior to contacting with the enzyme solution. In the alternative, the enzyme coated particles may be subject to comminution after treatment. After thus combining the enzyme and substrate, the iron may be combined therewith.

The oxygen scavenging coating or ink compositions employed herein further comprise a non-aqueous liquid vehicle and an organic binder polymer with the proviso that the multicopper oxidase enzyme, the oxidizable substrate, and the iron are sufficiently intermixed to allow oxidation of the substrate and the iron in the presence of molecular oxygen upon exposure to moisture

In one method, the substrate particles are subject to milling wherein the grinding medium is the vehicle. Enzyme in powder form or concentrated aqueous solution is added during milling to produce dispersion coated substrate particles. The particles so-produced are then dispersed with iron particles to form the composition hereof.

Alternatively, it is possible to prepare the oxygen scavenging composition by combining the components by direct addition of each to the vehicle while mixing. In general, the ingredients may be combined in any order.

In another method, the oxygen scavenging composition is prepared and then combined with the vehicle. The dispersion of the composition in the vehicle can be accomplished by using a high-speed disperser, sand mill, bead mill, or media mill. The concentration of dispersed particles in the vehicle ranges from 0.1% by weight to about 33% by weight of the total composition.

The discussion following is directed to oxygen scavenging compositions where the polymer is soluble in the non-aqueous liquid vehicle. The polymer could be insoluble therein.

The choice of vehicle will depend largely upon the requirements of a specific application. There is no limitation on the choice of vehicle so long as it is selected to be compatible with the polymeric binder. Suitable vehicles include but are not limited to ethyl acetate, ethanol, toluene, tetrahydrofuran (THF), methyl ethyl ketone, isopropyl alcohol, dibasic esters, 2-ethyl-hexyl acetate, normal propyl acetate, n-butyl acetate, isopropyl acetate, dimethyl formamide, N-methyl pyrolodone, acetone, cyclohexane, ethylene glycol diacetate, and mixtures thereof.

In one embodiment, the oxygen scavenging coating is employed for food packaging, so compatibility of the vehicle and the polymer with food is important. In typical use, oxygen scavenging composition, in the form of an ink, is coated onto a surface, and the vehicle is evaporated leaving behind a solid oxygen scavenging coating or film on the surface. Although the vehicle is removed prior to use of the oxygen scavenging film, food contact by trace amounts of vehicle cannot be excluded as a possibility. The package can be designed so that the activated oxygen scavenging coated surface is in diffusive oxygen contact with the food item, but is prevented from actual physical contact by virtue of compartmentalization, or a physical barrier. A physical barrier may be an oxygen and moisture permeable film laminated, extrusion coated or solvent coated onto the activated oxygen scavenging film.

In another embodiment, the oxygen scavenging composition is applied to a surface by printing. Compatibility with or inertness to the printing surface is necessary.

Suitable polymers are either soluble or dispersible in the selected vehicle and are capable of forming a film or layer, upon deposition and evaporation of the vehicle. The particular selection of polymer will depend upon the suitability for a particular use. Polymers soluble in a vehicle are preferred. In an embodiment of the invention intended for use in food packaging, the polymer should be safe to use with food. If rapid oxygen scavenging is desired, then the polymer should be permeable to oxygen and water vapor. Examples of suitable binder polymers include but are not limited to ethylene vinyl acetate copolymers or terpolymers, such as Elvax® or Elavaloy® available from DuPont; cellulosic polymers, such as cellulose acetate, cellulose acetate propionate, or cellulose acetate butyrate; acrylic polymers, such as poly(butylmethacrylate) or poly(butyl methacrylate-co-methyl methacrylate); polyurethanes prepared by reacting excess aliphatic diisocyanate with polyether or polyester polyol, diamine and terminating agent; cosolvent polyamides; and polyesters, such as polyethylene sebacate or poly(butylene adipate); or mixtures thereof.

In one embodiment, one part by weight of the multicopper oxidase enzyme, oxidizable substrate, and iron is combined with 0.05 to 20 parts by weight of the polymer in the vehicle. In one embodiment, the polymer is insoluble in the non-aqueous liquid vehicle so that the oxygen scavenging coating or ink composition hereof comprises a dispersion of both the polymer and the multicopper oxidase enzyme, the oxidizable substrate, and iron in the non-aqueous liquid vehicle. In another embodiment, the polymer is soluble in the vehicle, and the oxygen scavenging coating or ink composition hereof comprises a dispersion of the multicopper oxidase enzyme, the oxidizable substrate, and iron in a solution of the polymer in the non-aqueous liquid vehicle. In an alternative embodiment, the enzyme resides on or is disposed upon the surface of the oxidizable substrate. In another embodiment, the enzyme is dispersed within the oxidizable substrate.

The discussion following is directed to embodiments wherein the polymer is soluble in the non-aqueous liquid vehicle. However, it shall be understood that the discussion applies to embodiments in which the polymer is dispersed as particles in the vehicle.

As a general rule, the least amount of polymer should be employed consistent with viscosity considerations and the degree of binding necessary. For a given amount of substrate, there are advantages to higher substrate to polymer ratios. Among these are that a given volume of ink will have higher scavenging capacity, the materials cost for a given scavenger capacity is lower, polymers with limited solubility in the vehicle will still dissolve, and the polymers employed may be less permeable to oxygen or water while still permitting a useful oxygen scavenging coating.

Other additives may include hygroscopic agents, such as fructose, silica gel, or polyvinyl alcohol; plasticizers soluble in the polymer; dispersing agents, such as Tween® 80, Triton® X-100 and Pluronic®; pigments, and such others that are commonly employed in the art for modifying the properties of polymers and inks. A dispersing agent helps to form a suspending medium promoting uniform and maximum separation of the fine solid particles.

In a typical application, a surface is contacted with a composition comprising a mixture of the vehicle, the polymer, and the enzyme, substrate, and iron dispersed therewithin. The vehicle is then evaporated thereby disposing upon the surface the oxygen scavenging coating composition in the form of a film, sheet, or layer.

In a typical use, the oxygen scavenging coating ink is applied to a surface, such as the inner surface of a food package, and the vehicle evaporated leaving behind the oxygen scavenging coating comprising a polymeric matrix binding the particles of the composition hereof. In the presence of moisture or water vapor the oxygen scavenging reaction is activated. The ink or coating can be applied to a surface according to methods well-known in the art. Examples of suitable surfaces include: wood pulp filter paper, glass fiber filter paper, paperboard, fabric, nonwoven fabrics, polymer films, metal foils, and label stock. Examples of suitable methods of application of the composition include solution-casting, spraying, blotting, knife over roll coating, curtain coating, dip coating, metering rod coating, reverse roll coating, painting with an applicator, and printing techniques including gravure, screen, ink jet, and flexographic.

In other applications, the dispersions can be used to make excellent printing inks. The inks can be formulated to a suitable viscosity for screen printing, gravure printing, or flexographic printing. Additives, such as fillers or pigments may be incorporated without disturbing functionality.

The vehicle employed in forming the ink or coating can be selected to allow formulations that are stable over periods of months. The unhydrated particles dispersed in the non-aqueous vehicle are unreactive with atmospheric oxygen which allows printing on unmodified equipment. Furthermore, fast-drying non-aqueous vehicles enable the use of high speed printing methods.

To prepare an ink formulation, particles of the composition hereof are dispersed in a vehicle using a media mill, sand mill, or high speed disperser forming a dispersion. The dispersion should contain 40%-70% by weight of scavenging particles, preferably 55% to 60%; an amount of dispersant may be added equal to ½ to 1/10 the weight of scavenging particles, preferably ¼ to ⅕; and the remainder should be vehicle. Dispersion should continue until the fineness of grind measured on a Hegman gage is between 4 and 8, preferably between 6 and 8.

In another embodiment of ink preparation, the ink formulation is prepared by combining 90.5-50 wt-% of a vehicle and 4.5-30 wt-% of a soluble polymeric binder, and 5-30% of the mixture of particles of the enzyme, substrate and iron. Optionally, the coating or ink composition may contain, by weight, plasticizer of 0 to 5% and dispersant of 0 to 8%.

The following Examples illustrate the invention.

### EXAMPLES

### Materials

Unless otherwise indicated, all materials used in the Examples were obtained from Sigma Chemical Corporation (St. Louis, Mo.).

Myceliophthora thermophilia laccase was obtained from Novozymes (Franklinton, N.C.) as DeniLite® II Base (Item #NS37008) The enzyme was supplied on an inert carrier. The enzyme represented about 2% of the total weight and was washed from the carrier using a buffer (50 mM morpholineethanesulfonic acid, pH 5.5, 1 mM ethylenediamine tetraacetic acid) to yield a solution containing 20 mg/ml enzyme.

Myceliophthora thermophilia laccase was also supplied by Novozymes in a concentrated form (NS44141) containing 95 grams of enzyme per liter of aqeuous solution, and was of sufficient purity to be used directly.

### Examples 1-3 and Comparative Examples A-D

The purpose of these experiments was to compare the time required to scavenge a fixed volume of oxygen using compositions of the invention versus using compositions of the art.

Calcium ascorbate powder was produced by spray drying a 25% by weight solution of calcium ascorbate in water. Spray drying was done in a 3 ft diameter, 15 ft³ volume, pilot spray dryer (Mobile Minor™, Niro Inc, Columbia, Md.). The dryer was supplied with drying air heated to 228 C. A peristaltic pump (Masterflex, Barnant Co, Barrington, Ill.) was used to meter feed solutions to the spray-drying nozzle. A dual fluid nozzle (SU4, Spraying Systems Co., Chicago, Ill.) supplied with 30 psi N₂ was used to spray slurries into the volume of the dryer. The 75° C. aerosol was discharged to an 8 ft² bag filter where entrained solids were disengaged from the spent drying gas.

A combination of calcium ascorbate and laccase powder was produced by spray drying in the manner described supra, except that 0.25% by weight of the entire solution of laccase enzyme was added to the 25% by weight solution of calcium ascorbate in water employed supra.

The resulting particles were combined with nominal 44 μm diameter iron powder (North American Hoganas) in the amounts shown in Table 1 below, to form the scavenger powder.

Inks were made by adding 10 g of “scavenger powder” which consisted of various combinations of iron, calcium ascorbate, and laccase as listed in Table 1, with 20 g of ethanol. The powder was dispersed by shaking in bottles containing an equal volume of 0.5 millimeter ceramic beads on a gyrotary shaker at 400 rpm for 30 min. To the dispersion so formed was added by pouring 30 g of vehicle containing 25% cellulose acetate (Eastman CAP 504-0.2 and 1% triacetin (Eastman) dissolved in ethyl acetate. The dispersion and vehicle were mixed on a gyrotary shaker at 400 rpm for 30 min.

TABLE 1

| | | | Elapsed time |
|---|---|---|---|
| | | Substrate or Enzyme | to scavenge |
| | Iron Content (g) | Substrate Content (g) | 50 cc/g |
| Example 1 | 0.1 | 9.9 g laccase/ascorbate | 46 hr |
| Example 2 | 0.5 | 9.5 g laccase/ascorbate | 42 hr |
| Example 3 | 1.5 | 8.5 g laccase/ascorbate | 32 hr |
| Comp. Ex A | 0.1 | 9.9 g ascorbate | 115 hr |
| Comp. Ex B | 0.5 | 9.5 g ascorbate | 70 hr |
| Comp. Ex C | 1.5 | 8.5 g ascorbate | 57 hr |
| Comp. Ex D | 0.0 | 10 g laccase/ascorbate | 154 hr |

The resulting inks were drawn down on polyethylene sheet to form dry films approximately 100 microns in thickness which were released from the polyethylene as clean ink films. The ink films were weighed and inserted into test bottles. To provide humidity for activation, about 1 g of DuPont Sontara® SPS™ towel was inserted into each bottle and soaked with approximately 4 g of deionized water, in a manner that ensured no physical contact between the ink film and the wet towel.

Measurement and Results

Continuous time-course measurements of headspace oxygen concentration were performed with an oxygen analyzer from Sable Systems International. The analyzer consisted of one FC1-FC sensor fuel-cell sensor per vessel, an 8-channel interface to process the output of the sensors, and a computer running ExpeData® software to store the readings. The temperature of the bottles' environment was monitored with a thermocouple and recorded. Each sensor was fitted to a drilled hole in the PTFE cap of a 150-ml pressure vessel (Chemglass model CG-1880-41) and the junction between the sensor and the cap was sealed with Aquaseal® urethane sealant. Oxygen concentration measurements were recorded at 25° C. at five-minute intervals. Oxygen scavenged in cubic centimeters of O₂ per gram of ink film (ccO₂/g) was calculated from the % O₂ measurements using the formula ccO₂/g=(Δ% O₂/100)(bottle volume in ml)/(dry ink film mass in g). Results are shown in Table 1 above.

### Example 4

### Preparation of Ink and Package

Calcium ascorbate/laccase powder was produced by spray drying a 25% by weight solution of calcium ascorbate in water containing 0.25% laccase enzyme. Spray drying was done in a 3 ft diameter, 15 ft³ volume, pilot spray dryer. The dryer was supplied with drying air heated to 228° C. A peristaltic pump was used to meter feed solutions to the spray-drying nozzle. A Spraying Systems SU4, dual fluid nozzle supplied with 30 psi N₂ was used to spray slurries into the volume of the dryer at 75° C. The aerosol formed thereby was discharged from the dryer into an 8 ft² bag filter where entrained powder were separated from the spent drying gas.

0.75 kg of the thus prepared powder was mixed with 0.84 kg of propanol and 0.50 kg of Pegosperse 400 MO obtained from Lonza, Inc, Allendale, N.J. This slurry was then media milled in a Premier HM15 mill using an 80% loading of 1.2 to 1.6 mm ER120S media until a mean particle size of 3 um was achieved in the resulting dispersion.

1.48 kg of the dispersion so formed was combined with 0.65 kg of propanol, 1.14 kg of Cydrothane® SB4040 polyurethane resin from from Cytec Industries, 0.38 kg of Nanofil® 2 nano-sized clay, available from Rockwood Clay Industries GmBH, and 0.14 kg of 3 micrometer average particle size carbonyl EQ iron powder available from BASF. These were mixed vigorously using an air driven Cowles blade at high speed for 30 minutes.

The oxygen scavenging ink thus prepared was used in a flexographic press to print blocks of oxygen scavenger on a plastic film. The press was a 10″ Mark Andy Inc system 2200 flexographic printing press with 8 print stations. Only stations one and two—fitted with 33 BCM (billion cubic micrometers/square inch) anilox rolls—.were employed. Cyrel® flexographic printing plates (available from the DuPont Company, Wilmington, Del.) were used to apply two impressions of the scavenger ink The scavenger was printed on PVDC-coated 0.5 mil polyester film at a speed of 100′/min (30.5 m/min) in the form of 3.5×5 inch blocks, with a coating areal density of ca. 0.07 g/55 cm².

The Cyrel® flexographic printing plates used at both stations were patterned with four 3.5×5 inch rectangles. The plates were Cyrel® DPL 0.067 inches thick with a floor of 0.019-0.021 inch. The image was a 3.5×5 inch patch containing a crosshatch pattern of 0.05 point rules spaced 100 micrometers apart. The plates were made on a Dupont Digital Cyrel® system using solvent wash. A portion of the plates had a rectangular pattern, showing a microstructure wherein an array of square depressions, were formed on the plate. The depressions were separated by a series of perpendicular, 0.05 point lands, spaced 100 micrometers apart.

The thus printed film was extrusion coated with Elvax® 3200-2, ethylene-vinyl acetate copolymer resin available from the DuPont Company, using an Egan pilot coater. A 2.5 inch ER-WE-PA 28:1, air cooled extruder (available from Davis Standard) was used. Extruder temperatures were as follows: zone 1=270° F., zone 2=360° F., zone 3=416° F., zone 4=444° F., the remainder of the zones and die=450° F. The die was a 40″ Cloeren Bead Reduction Die set to a gap of 0.030 inches and deckled to 0.040″. The chill roll temperature was 50° F. The line speed was 200 feet/min and the extruder speed was adjusted to give a coating weight of 5 lb/ream on 36″ wide 30 lb kraft paper.

A 0.25 inch wide strip of Scotch Adhesive Transfer Tape 924 (3M Industrial Tape and Specialties Division) was applied widthwise to each end of the slipsheet described above, on the back side. The slipsheets were dropped onto the kraft paper web of the extrusion coating so that the transfer tape adhered the slipsheet to the kraft paper substrate, which carried said slipsheet through the coating section of the pilot coater. The coated kraft paper was unwound and the coated slipsheets removed for testing and fabrication.

The extrusion-coated film was used as lidding film by heat sealing the extruded EVA layer to preformed polyester trays on an Orics (model VGF 200, Orics Industries Inc., College Point, N.Y.) vacuum tray sealer. The sealed trays had an internal volume of 430 cc.

A moist paper towel was sealed within the trays to provide a humidity source to activate the scavenging reaction. The sealed packages were stored at 4 degrees C. Oxygen was measured with a Checkmate II (PBI-Dansensor Ringsted, Denmark). At 50 hours after sealing, the oxygen level had dropped from 21% to 19.7%, and after 600 hours the level had declined to 19.4%

Trays were also sealed after filling with fresh pasta and showed oxygen levels dropping from 21% to 19.1% after 50 hours and dropping to 18.2% after 600 hours

What is claimed is:

1. A method for preparing an activable oxygen scavenging film comprising:
applying a composition to a surface, wherein the composition comprises a non-aqueous liquid vehicle, a multicopper oxidase enzyme, an oxidizable substrate, metallic iron, and an organic binder polymer, wherein the polymer is dissolved or dispersed in the liquid vehicle, wherein the enzyme, the substrate, and the iron are in particulate form and dispersed in the liquid vehicle; and
evaporating the liquid vehicle.

2. The method of claim 1 further comprising combining the activable oxygen scavenging film with one or more additional layers to form a multi-layer structure.

3. The method claim 2 wherein at least one of the additional layers is a polymeric film or sheet.

4. The method of claim 3 wherein the polymeric film or sheet acts as a functional barrier.

5. The method of claim 3 wherein the polymeric film or sheet acts as a heat sealing layer.

6. A method for preparing an oxygen reduced package comprising:
applying a composition to a surface wherein the composition comprises a non-aqueous liquid vehicle, a multicopper oxidase enzyme, an oxidizable substrate, metallic iron, and an organic binder polymer, wherein the polymer is dissolved or dispersed in the liquid vehicle, wherein the enzyme, the substrate, and the iron are in particulate form and dispersed in the liquid vehicle;
evaporating the liquid vehicle forming an activable oxygen scavenging coated surface;
preparing a package having an interior and an exterior, wherein the interior of the package comprises the activable oxygen scavenging coated surface;
providing a source of water vapor wherein the activable oxygen scavenging coated surface is activated; and
sealing the package.

7. The method of claim 6 further comprising applying a functional barrier permeable to oxygen and water vapor at a location to effectively sequester contents of the package from the activable oxygen scavenging coated surface.

8. The method of claim 1 wherein the organic binder polymer is water-insoluble.

9. The method of claim 6 wherein the organic binder polymer is water-insoluble.

10. The method of claim 1 wherein the organic binder polymer is selected from the group consisting of poly(ethylene-co-vinyl acetate), cellulose acetate, cellulose acetate propionate, cellulose acetate butyrate, poly(ethylene-co-vinyl acetate-co-carbon monoxide), poly(butylmethacrylate), and mixtures thereof.

11. The method of claim 6 wherein the organic binder polymer is selected from the group consisting of poly(ethylene-co-vinyl acetate), cellulose acetate, cellulose acetate propionate, cellulose acetate butyrate, poly(ethylene-co-vinyl acetate -co-carbon monoxide), poly(butylmethacrylate), and mixtures thereof.

12. The method of claim 1 wherein the liquid vehicle is selected from the group consisting of ethyl acetate, ethanol, toluene, and tetrahydrofuran.

13. The method of claim 6 wherein the liquid vehicle is selected from the group consisting of ethyl acetate, ethanol, toluene, and tetrahydrofuran.

14. The method of claim 1 wherein the oxidizable substrate is selected from the group consisting of calcium ascorbate, sodium ascorbate, ascorbic acid, ammonium ascorbate, and mixtures thereof.

15. The method of claim 6 wherein the oxidizable substrate is selected from the group consisting of calcium ascorbate, sodium ascorbate, ascorbic acid, ammonium ascorbate, and mixtures thereof.

16. The method of claim 1 wherein the enzyme and the substrate in particulate form comprises particles in the range of 1 to 100 micrometers.

17. The method of claim 6 wherein the enzyme and the substrate in particulate form comprises particles in the range of 1 to 100 micrometers.

18. The method of claim 1 wherein the multicopper oxidase is laccase or ascorbate oxidase.

19. The method of claim 6 wherein the multicopper oxidase is laccase or ascorbate oxidase.

20. The method of claim 6 wherein the source of water vapor is food.

21. A shaped article having a surface coated with an oxygen scavenging coating, said oxygen scavenging coating comprising a multicopper oxidase enzyme, an oxidizable substrate, metallic iron, and a binder polymer, said enzyme, substrate and iron being in particulate form and dispersed in said polymer.

22. The shaped article of claim 21 further comprising a polymeric functional barrier disposed upon the oxygen scavenging coating.

23. An article comprising a sealed package having an interior and an exterior, said interior comprising a surface coated with an oxygen scavenging coating, said oxygen scavenging coating comprising a multicopper oxidaxe enzyme, an oxidizable substrate, metallic iron, and a binder polymer, the enzyme, substrate, and iron being in particulate form and dispersed within said polymer.

24. The article of claim 23 further comprising moisture in said interior sufficient to activate an oxygen scavenging reaction.

25. The article of claim 24 further comprising a food item disposed in the interior of said package.
